(19) United States
(12) Patent Application Publication
(10) Pub. No.: US 2024/0256334 A1
(43) Pub. Date: Aug. 1, 2024

(54) Computer-Implemented Method And An Electronic Control Unit For A Deterministic Data Communication In A Partitioned Embedded System

(71) Applicant: Vitesco Technologies GmbH, Regensburg (DE)

(72) Inventors: Denis Claraz, Toulouse (FR); Ralph Mader, Bad Abbach (DE); Rudolf Sieber, Obertraubling (DE); Martin Alfranseder, Obertraubling (DE); Kevin Marteil, L'Union (FR)

(73) Assignee: Vitesco Technologies GmbH, Regensburg (DE)

(21) Appl. No.: 18/631,145

(22) Filed: Apr. 10, 2024

Related U.S. Application Data
(63) Continuation of application No. PCT/EP2022/073167, filed on Aug. 19, 2022.

(30) Foreign Application Priority Data
Oct. 11, 2021 (DE) 10 2021 211 440.7

(51) Int. Cl. G06F 9/48; G06F 9/38; G06F 9/54

(52) U.S. Cl. CPC G06F 9/4881; G06F 9/3836; G06F 9/54

(57) ABSTRACT

The invention relates to a computer implemented method and to an electric control unit for a deterministic data communication in a partitioned embedded system. A software of the embedded system includes a plurality of software clusters having functional tasks and cross cluster communicational tasks. The method includes providing an execution schedule. The method also includes providing in the execution schedule, predefined functional windows for the functional tasks of the plurality of the software clusters and dedicated cross cluster communicational windows for the cross cluster communicational tasks of the plurality of the software clusters. The cross cluster communicational windows are distinct from the functional windows.

### CROSS-REFERENCE TO RELATED APPLICATIONS

This application claims the benefit of PCT Application PCT/EP2022/073167, filed Aug. 19, 2022, which claims priority to German Application 10 2021 211 440.7, filed Oct. 11, 2021. The disclosures of the above applications are incorporated herein by reference.

### TECHNICAL FIELD

The disclosure relates to a computer-implemented method and to an electronic control unit for a deterministic data communication in a partitioned embedded system, for example, of an automotive open system architecture (AUTOSAR). The software of the embedded system includes a plurality of software clusters having functional tasks and cross cluster communicational tasks. The software cluster of the embedded system includes a plurality of functional tasks. Further, the software clusters of the embedded system include a plurality of cross communicational tasks for communication between the different software clusters.

### BACKGROUND

In a classic AUTOSAR based software system, the communication of data between the different software tasks is generally performed inside the task: right after the start of the task for the data, which is consumed, and just before termination of the task for the data produced. Applying this conventional principle on a partitioned system means that any task of a partition may interact/communicate with any task of another partition.

The described conventional behavior above creates problems with respect to a deterministic behavior of the communication between the different tasks, as the duration and jitter of a single task typically shows variations. For example, the communication between two tasks is conventionally not deterministic due to tasks jitters or varying runtime. For software clusters (a set of tasks) communicating with another software cluster, LET (logical execution time) provides determinism, but only for each individual task, not for a complete system and in a stable way across successive project updates (i.e., task content updates). Especially in multicore systems this could lead to unpredictable delays in the communication between the different software clusters. Another problem of the conventional communication between the different software clusters is that the data which is consumed in different functional tasks would be captured as often as used and therefore this leads to an instability or to an inconsistency inside the software clusters. Similarly, data produced in different functional tasks would lead to multiple communications towards the consumers, leading also to possible inconsistencies.

In addition, the conventional communicational architecture does not allow optimization on the system (multi-cluster) level such as the software cluster internal production rate is used for the cross-cluster communication, even if the consuming software cluster will be satisfied with a lower production rate. In addition, in the conventional system, a full decoupling between the different software cluster is not reached, and an upgrade of one software cluster may have a functional impact on another (stable) one, when the production of an output is moved from one task to another, introducing (or removing) a delay on the communicated data.

### SUMMARY

The disclosure provides a computer-implemented method and an electronic control unit which creates an advantageous deterministic data communication in a partitioned embedded system.

One aspect of the disclosure provides a computer-implemented method for a deterministic data communication in a partitioned embedded system. The partitioned embedded system includes software. The software of the embedded system includes a plurality of software clusters having functional tasks and cross cluster communicational tasks. The functional tasks are designed to execute functional tasks within the corresponding software cluster with provided data in the partitioned embedded system and the cross cluster communicational tasks are designed to execute cross cluster communicational tasks between the different software clusters of the partitioned embedded system. The computer-implemented method for the deterministic data communication in the partitioned embedded system includes providing an execution schedule which includes predefined functional windows for functional tasks of a plurality of the software clusters. The execution schedule defines the different functional windows during which the functional tasks of the plurality of the software clusters are executed during the operation of the partitioned embedded system. The execution schedule is therefore designed to fulfill the desired tasks of the partitioned embedded system.

The computer-implemented method also includes providing in the execution schedule dedicated cross cluster communicational windows for communicational tasks of the plurality of the software clusters. The cross cluster communicational windows are distinct from the functional windows. In other words, the execution schedule further includes the cross cluster communicational windows in which the predefined cross cluster communicational tasks are executed. The cross cluster communicational tasks provide the necessary data communication between the different software clusters. The transmitted data is afterwards used for example in a functional task of a corresponding other software cluster. In other words, the cross cluster communicational tasks read data from other software clusters for input into the functional tasks and the cross cluster communicational tasks write output for other software clusters as output data of the functional tasks. The communicational data can therefore, for example, provide the desired communication from one functional task which writes output to another functional task for another software cluster as desired input. The cross cluster communicational windows are distinct/independent from the functional windows. This means, that the cross cluster communicational windows are not linked to the functional windows. It is for example considerable that the cross cluster communicational windows are located at completely different time slots in the overall execution schedule than the time slots of the functional windows. It is therefore possible to place the cross cluster communicational windows as desired in the overall execution schedule to create the desired deterministic communication independent from the execution of the functional tasks during the functional windows.

Additionally, the computer-implemented method includes executing the schedule during operation of the partitioned embedded system. The functional tasks of the software clusters are executed in the predefined functional windows and the cross cluster communicational tasks of the software clusters for cross-cluster communication are executed in the dedicated cross cluster communicational windows, whereby the deterministic data communication in the partitioned embedded system for cross-cluster communication is realized.

Implementations of the disclosure may include one or more of the following optional features. In some implementations, during operation of the partitioned embedded system, the executional schedule of the partitioned embedded system is executed, which means that the functional tasks of the software clusters are executed in the predefined functional windows, and the cross cluster communicational tasks of the software clusters for cross-cluster communication are executed in the dedicated cross cluster communicational windows. For example, one functional task within a first software cluster is executed where output data is generated. Afterwards, a second functional task of the first software cluster is executed where other output data is generated. Afterwards, a cross cluster communicational task of the first software cluster is executed where the two output data of the two former functional tasks are communicated to a second software cluster, which communicates the data to at least one of its internal functional tasks. Therefore, it is possible to create a very specific deterministic communication between the different software clusters which allows the desired communication between different software clusters without any data corruption during operation of the different functional tasks. This is possible because the communication between the different software cluster is only done during the predefined cross cluster communicational windows with the cross cluster communicational task so that the required input and output data of the different functional task is always provided to the required functional task so that the overall execution of the partitioned embedded system is realized and achieved without any data delay or data corruption. The cross cluster communicational windows can be positioned in the execution schedule at a predefined and a stable position, in a coordinated way on system level (multi-cluster level). They can be scheduled in a consecutive and synchronized order, even across cores in a multicore system or even across different device in a multi-microprocessor and/or multi-microcontroller system. The cross cluster communicational tasks in the cross cluster communicational windows may have relatively short dedicated executional windows (short runtime) and probably a high priority to reach a reproducible and deterministic behavior of the partitioned embedded system. The described computer-implemented method creates therefore a very deterministic behavior regarding data communication in the partitioned embedded system. It is therefore possible that the overall system as a high level of data determinism.

In some implementations, the freedom from interference in time between communication of the different software clusters is increased and the possibility of independent releases and validations of different software cluster in the partitioned embedded system is further increased. Further, it is possible to implement a defined timing behavior for input and output between the different software clusters and with this it is possible to reduce the number of copies into the different software cluster memory which saves microprocessor/microcontroller resources of the partitioned embedded system. Another advantage of the computer-implemented method is that it enables a top-down approach for designing the software clusters and the communication between them, by a prior fixation of the cross cluster communicational windows for the complete system.

In some examples, the partitioned embedded system uses an automotive open system architecture (AUTOSAR). The implementation of the method is easy if the partitioned embedded system uses the AUTOSAR architecture.

In some implementations, the functional tasks of the software clusters have a determined priority and the cross cluster communicational task of the software clusters have a determined priority, where the priority of the cross cluster communicational task of the software clusters is higher compared to the priority of the functional tasks of the software clusters so that one of the cross cluster communicational tasks is executed prior to one of the functional tasks if they compete for resources. According to this implementation, the communicational tasks are executed prior to functional tasks. This ensures that the data communication between the different software clusters and between the different functional tasks has the required high quality, determinism and reproducibility. It is therefore possible to assure that all the functional tasks have the required input data prior to their execution.

In some examples, the software clusters include one cross cluster communicational window for input communication and/or one cross cluster communicational window for output communication, where in the cross cluster communicational windows for input communication the cross cluster communicational tasks read input data and in the cross cluster communicational windows for output communication the cross cluster communicational tasks write output data. In other words, the cross cluster communicational windows are separated in cross cluster communicational windows for input communication and cross cluster communicational windows for output communication. This allows a desired separation for dedicated cross cluster communicational windows for input communication and a dedicated separation for cross cluster communicational windows for output communication. If, in some examples, it is only necessary to have an input communication, then a dedicated cross cluster communicational window for input communication can be foreseen in the overall execution schedule and if it is only necessary to have an output communication, then a dedicated cross cluster communicational window for output communication can be foreseen in the overall schedule. This allows an even better and precise deterministic communication in the overall partitioned embedded system. In some examples, it is possible, that one cross cluster communication window for output communication is immediately followed by one cross cluster communicational window for input communication. In this case, the output communication is immediately followed by input communication so that the desired input for functional task is provided and that the desired output is sent to the required functional tasks of a different software cluster.

In some implementations, a microprocessor of the partitioned embedded system includes a plurality of cores, and the cross cluster communicational tasks provide communication between the different cores of the microprocessor. The computer-implemented method provides the required deterministic data communication between different cores of the microprocessor of the partitioned embedded system. Different software clusters may be executed on different cores of the microprocessor. These different software clusters require communication across different cores of the microprocessor with the computer-implemented method having the communicational windows for example on the different cores. It is therefore possible to have the deterministic communication between the different software clusters on the different cores of the microprocessor. It is therefore also possible to have the deterministic and very specific communication between the plurality of the different cores of the microprocessor.

In some implementations, the partitioned embedded system includes a plurality of microprocessors and/or microcontrollers where each of the microprocessors/microcontrollers may have a plurality of cores. Having the software cluster in the partitioned embedded system with the dedicated cross cluster communicational windows on each microprocessor allows the deterministic data communication between the different microprocessors and between the different cores of the different microprocessors. It is therefore in the overall partitioned embedded system possible to have deterministic, specific and stable data communication during operation of the partitioned embedded system.

In some examples, all of the cross cluster communicational windows are provided only on one specific core of a multicore-/multiprocessor-system. Accordingly, the microprocessor includes multiple cores and all of the cross cluster communicational windows for the cross cluster communicational tasks are provided specifically only on one core. This allows a relatively simple design and allocation of the different cross cluster communicational tasks of the embedded system. Therefore, a synchronization between the different cores is not needed when an update for one cross cluster communicational task is required, which reduces the complexity of the system. Further, conflicts can be avoided in case of synchronous updates for different cores.

In some implementations, the different cross cluster communicational windows are provided on different cores of the microprocessor/system. Accordingly, the microprocessor includes different cores and on these different cores, the different cross cluster communicational windows for the cross cluster communicational tasks are provided. For example, each core of the different cores of the microprocessor includes at least one dedicated cross cluster communicational window for the desired cross cluster communicational tasks. Grouping on the same core the functional tasks and the cross cluster communicational tasks of the same software cluster allows an advantageous control of the flow between the cross cluster communicational and the functional tasks and improves the scheduling of the complete task set up. It allows a core local allocation of the memory which improves the performances.

In some examples, the dedicated cross cluster communicational windows for input or output communication are followed or preceded by at least one functional window. In other words, after one cross cluster communicational window for input communication follows at least one functional window for one functional task and/or before one cross cluster communication window for output communication precedes at least one functional window for one functional task. For example, a five millisecond period of the execution schedule starts with a dedicated cross cluster communicational window for input communication, afterwards follows a first functional window for a first functional task which is again followed by a second functional window for a second functional task which is again followed by a third functional window for a third functional task which is followed by a dedicated cross cluster communicational window for output communication which completes this specific period, for example on one core of a microprocessor of the embedded system. Accordingly, it is therefore possible to read the required input data during the dedicated cross cluster communication window for input data and afterwards to execute the required functional task with the read input data and after the successful execution of the functional tasks to write the required output data during the dedicated cross cluster communication window for output communication to other software clusters. Overall, the communication between the different software clusters and the different cores of different microprocessors of the embedded system is very stable and deterministic. Therefore, the advantages are that the system and the method are more flexible in terms of placement versus intervals. It is sufficient to ensure that all functional tasks have produced the required output data before the start of the dedicated cross cluster communicational tasks for output communication, and that all functional tasks read the required input data after the end of the dedicated cross cluster communicational tasks for input communication. The actual use of the data can be moved from one functional task to another one without impact on the communicational tasks, as long as this condition is ensured.

In some implementations, the execution schedule includes execution periods in which predefined functional tasks are executed and where each execution period includes only one cross cluster input communicational window and only one cross cluster output communicational window. In other words, for each execution period, there is one dedicated cross cluster input communicational window and one dedicated cross cluster output communicational window for input communication and output communication. The cross cluster input communicational window may be at the beginning of the execution period and the cross cluster output communicational window may be at the end of the execution period. The functional windows for the predefined functional tasks may be between the cross cluster input communicational window and the cross cluster output communicational window. Before the first functional task, the cross cluster input communicational window with the cross cluster input communicational task is executed so that all the required input data for the predefined functional tasks is read from other software clusters. Afterwards, the functional tasks are executed which use input data and produce output data. Afterwards, the cross cluster output communicational window with the cross cluster output communicational task is executed to write the output data from the executed functional task to other software clusters. Accordingly, the overall architecture of the embedded system is advantageously simple and robust.

In some implementations, the execution schedule includes execution periods in which predefined functional tasks are executed, and each execution period includes one or more cross cluster input communicational windows and/or one or more cross cluster output communicational windows. Accordingly, the number of cross cluster input communicational windows and cross cluster output communicational windows within one execution period is not limited which means that the execution periods may have more than one cross cluster input communication windows and/or more one than cross cluster output communication window. For example, one execution period starts with one cross cluster input communication window which is followed by, for example, two functional windows which are followed by one cross cluster input communication window which is followed by one further functional window which is followed by one cross cluster output communicational window which completes the execution period. Accordingly, it is therefore possible to read or to write data to the specific functional tasks during the defined cross cluster input communicational windows or during the defined cross cluster output communicational windows even for example in the middle of the execution period. It is therefore possible to provide different communicational slots between different software clusters inside one period. This provides a huge freedom for designing the execution schedule for different tasks of the embedded system. Further, it allows advantageous fast communication paths between the different software clusters.

In some implementations, at least two cross cluster communicational windows are synchronized across at least two cores of the microprocessor. If, for example, the microprocessor includes two cores, the two cores execute in parallel different functional tasks of the schedule. Accordingly, the different schedules of the different cores have the cross cluster communicational windows at the same time slots. This leads to a parallel execution of the cross cluster communicational tasks across the different cores of the microprocessor. This example provides the advantage of a relatively simple architecture of the overall partitioned embedded system. Furthermore, if cross cluster communicational input tasks of different cores are simultaneous, and cross cluster communicational output tasks of different cores are simultaneous, there is no risk of concurrent access to the same data, and therefore no risk of inconsistency.

Another aspect of the disclosure provides an electronic control unit for a deterministic data communication. The electronic control unit is part of a partitioned embedded system where the embedded system includes a plurality of software clusters having functional tasks and cross cluster communicational tasks. The electronic control unit includes is designed to execute one of the preceding computer-implemented methods. It is conceivable that the electronic control unit may be an electronic control unit for a powertrain of a vehicle, for example a battery-electric vehicle. It is also conceivable that the electronic control unit is implemented in a server architecture of the electric vehicle. In some implementations, the electronic control unit includes several control units for example a master controller or a vehicle server which form the whole partitioned embedded system of, for example, a vehicle.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows in a schematic manner a prior art cross cluster communication between two software clusters.

FIG. 2 shows in a schematic manner an exemplary cross cluster communication between two software clusters.

FIG. 3 shows in a schematic manner two details of exemplary execution schedules.

FIG. 4 shows in a schematic manner an exemplary first execution schedule,

FIG. 5 shows in a schematic manner an exemplary second execution schedule.

FIG. 6 shows in a schematic manner an exemplary third execution schedule.

FIG. 7 shows in a schematic manner an exemplary fourth execution schedule.

FIG. 8 shows in a schematic manner an exemplary fifth execution schedule.

Like reference symbols in the various drawings indicate like elements.

### DETAILED DESCRIPTION

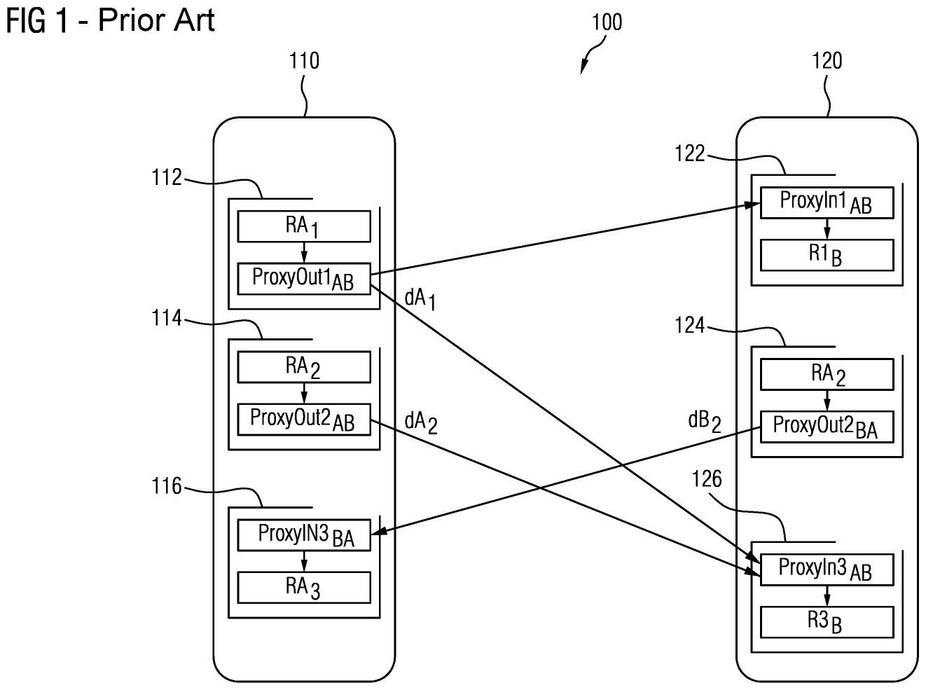

FIG. 1 shows a first diagram 100 of known data communication between two different software clusters 110, 120. The first diagram 100 includes a first cluster A 110 and a second cluster B 120. The cluster A 110 includes an interval A1 112 and an interval A2 114 and an interval A3 116. The cluster B 120 includes an interval B1 122, an interval B2 124 and an interval B3 126. The interval A1 112 executes a first functional task and produces output data. This output data DA1 is provided to the interval B1 122 and the interval B3 126. The interval A2 114 executes afterwards a second task which produces output data DA2. This output data DA2 is provided to the interval B3 126. The last interval A3 116 of the cluster A 110 reads input data of the interval B2 124 of the cluster B 120 and executes afterwards a third functional task. The interval B1 122 of cluster B 120 reads input data DA1 which was produced in the interval A1 112. The interval B1 122 executes afterwards a functional task. The interval B2 124 executes a functional task which produces output data DB2. This output data DB2 is provided to the interval A3 116 of the cluster A 110. The interval B3 126 of the cluster B 120 reads the input data DA1 and DA2 of the interval A1 112 and the interval A2 of the cluster A 110. The first diagram 100 illustrates the difficulty of the communication between different clusters 110, 120. Both clusters may be executed at the same time e.g., on separate cores. Data which was produced in one cluster should have been already transferred to the other cluster for execution of different tasks, but the task has already been executed with old or wrong data input due to the different communication slots. The overall communication between different software clusters according to this example is not deterministic and may lead to unpredictable delays in the communication between software clusters. Another problem is that the data which is consumed in different intervals would be captured as often as used and therefore this leads to instability or inconsistency inside the software clusters.

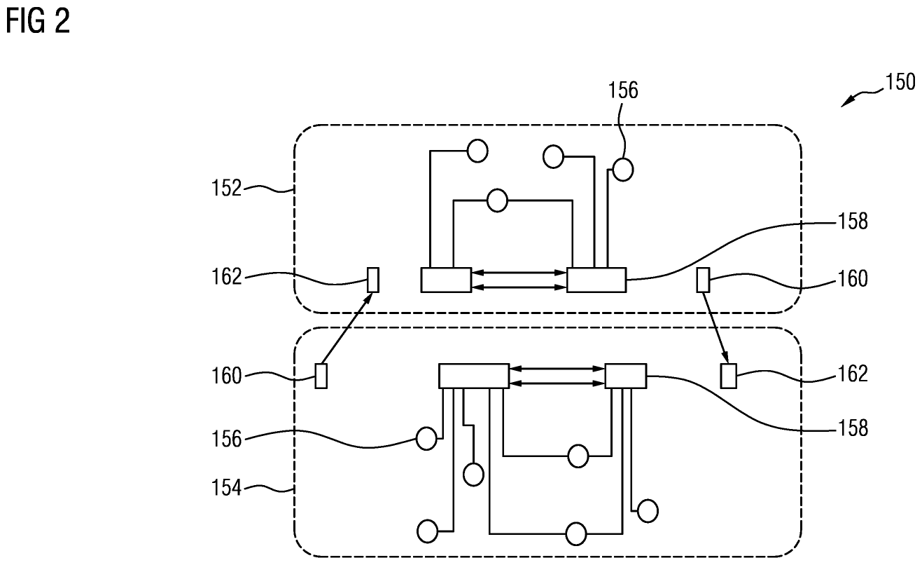

FIG. 2 shows a second exemplary diagram 150 of a cross cluster communication according to the disclosure. The second diagram 150 includes a first software cluster 152 and a second software cluster 154. The software cluster 152, 154 include different software components 156 which are, for example, software blocks. Further, the software clusters 152, 154 include different functional tasks 158 which are executed within functional windows (not shown). The different functional tasks 158 require different software components 156 for their tasks, this is shown with the linkage between the different functional tasks 158 and the different software components 156. Further, small arrows between the functional tasks 158 within one software cluster 152, 154 show a possible data communication between the different functional tasks 158 within one software cluster 152, 154. The diagram 150 further includes cross cluster output communicational tasks 160 and cross cluster input communicational tasks 162 which are executed within cross cluster communicational windows (not shown). The cross cluster output communicational tasks 160 write output data from one software cluster 154, 152 to another software cluster 152, 154. The cross cluster input communicational task 162 read input data from another software cluster 154, 152 to the own software cluster 152, 154. The cross software cluster data flow is shown in FIG. 2 with the arrows between the cross cluster communicational tasks 160, 162. The read input data is afterward provided to the functional tasks 158. And data produced from functional tasks 158 is afterwards provided to cross cluster output communicational tasks 160 for cross cluster communication. The cross cluster communicational tasks 160, 162 are distinct from the functional tasks 158 in the overall executional schedule which can be seen in FIG. 2. This independence allows the desired deterministic communication between the different software clusters 152, 154 compared to the communication between software clusters as shown in FIG. 1.

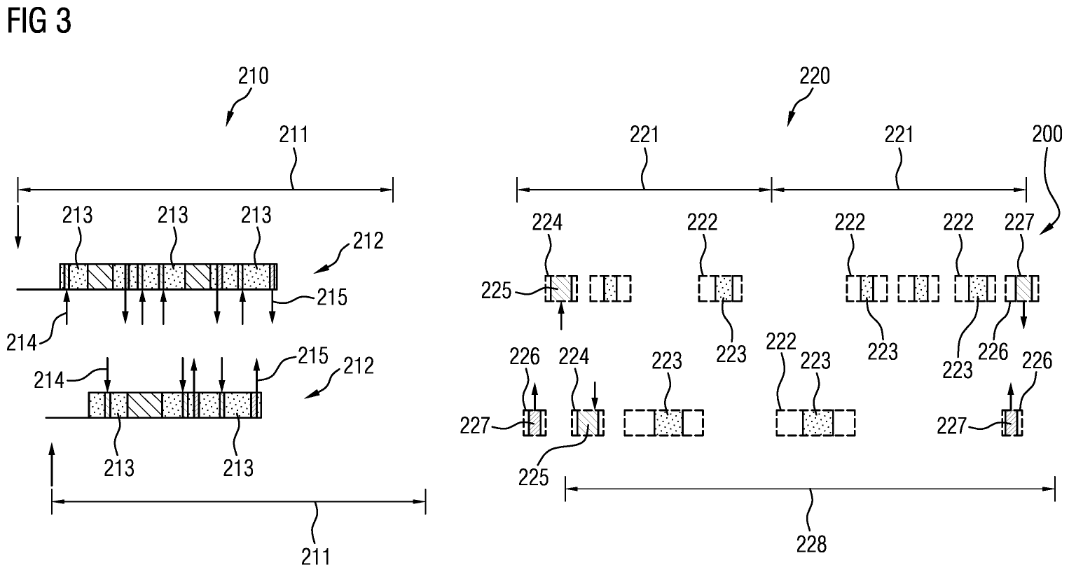

FIG. 3 shows a third Diagram 200 which includes a first Detail 210 of an execution schedule according to a conventional example and a second Detail 220 of an execution schedule according to a second example of the present disclosure. The first detail 210 shows the execution of tasks within a first period 211. The tasks are executed within functional windows 212. Task Execution 213 within the functional windows 212 is shown in FIG. 3 as grey rectangles. Further, within the functional windows 212 data is communicated to the functional task and from the functional tasks. The first Detail 210 shows for the data communication arrows for data input 214 and arrows for data output 215. The data input arrows 214 point towards the functional windows 212 and the data output arrows 215 point away from the functional windows 212. As it can be seen in the first detail 210 the communication between the different tasks is not deterministic which may lead to unstable data ages for task execution due to jitter issues. In contrast, the second Detail 220 shows a highly deterministic data communication between the different tasks according to the present disclosure. The second Detail 220 includes two second periods 221 within which functional windows 222, cross cluster input communicational windows 224 and cross cluster output communicational windows 226 are placed. The second Detail 220 further includes one third period 228 within which other functional windows 222, one other cross cluster input communicational window 224, and one other cross cluster output communicational window 226 are placed which may belong to a further software cluster. Within the functional windows 222 functional tasks 223 are executed, within the cross cluster input communicational windows 224 cross cluster input communicational tasks 225 are executed, and within the cross cluster output communicational windows 226 cross cluster output communicational tasks 227 are executed. The specific task execution is shown in the second detail 220 with grey or black rectangles. The cross cluster communicational tasks 225, 227 further have corresponding arrows. With the specific communicational windows 224, 226 it is possible to have a highly deterministic data communication between different software clusters or even different cores or electric control unit within the embedded system.

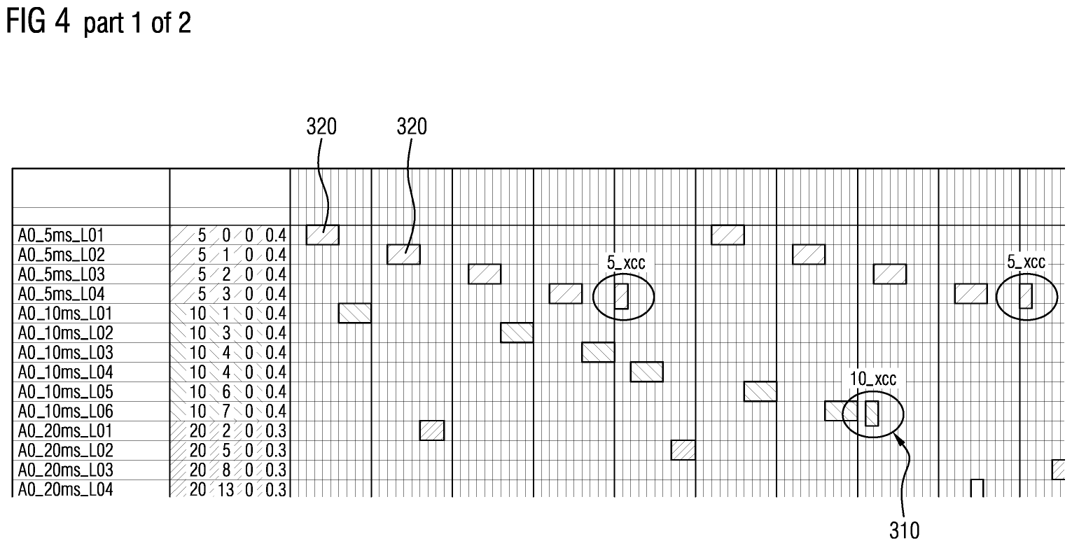

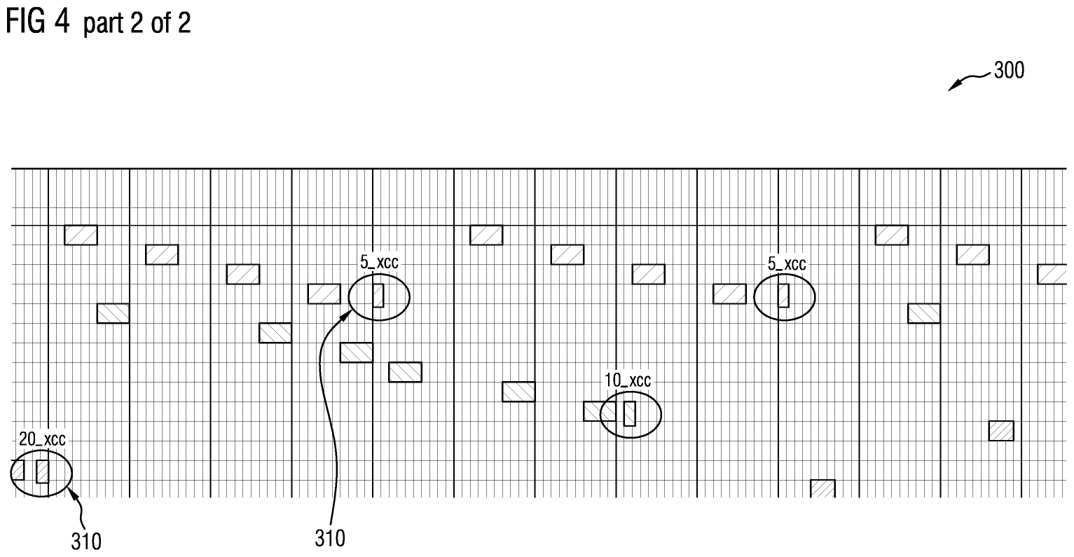

FIG. 4 shows a first executional schedule 300. The first execution schedule 300 includes functional windows 320 and cross cluster communicational windows 310. The functional windows 320 are scheduled for functional tasks (not shown) which are executed during the functional windows 320. The cross cluster communicational windows 310 are implemented in the execution schedule 300 for communicational tasks (not shown) between the different software clusters. Different software clusters may include different functional windows 320 and correspondingly different functional tasks which are executed during the different functional windows 320. Further, the software clusters include different cross cluster communicational windows 310 during which the different cross cluster communicational tasks for communication between the different software clusters is executed. As it can be seen in FIG. 4, the different cross cluster communicational windows 310 are placed in the first execution schedule 300 distinctly/independently from the different functional windows 320 which means that the cross cluster communicational windows 310 are only dedicated for specific cross cluster communicational tasks. It is therefore possible to have a highly deterministic communication between the different software clusters in the embedded system. The different functional tasks may be executed during the different functional windows 320 and may produce the output data. Afterwards, during an execution of a cross cluster communicational task in a cross cluster communicational window 310, the produced output data is, for example, sent to another functional task in another functional window 320. According to this example, it is therefore possible to have a highly deterministic and specific communication between the different software cluster of the partitioned embedded system of, for example, an AUTOSAR based software architecture.

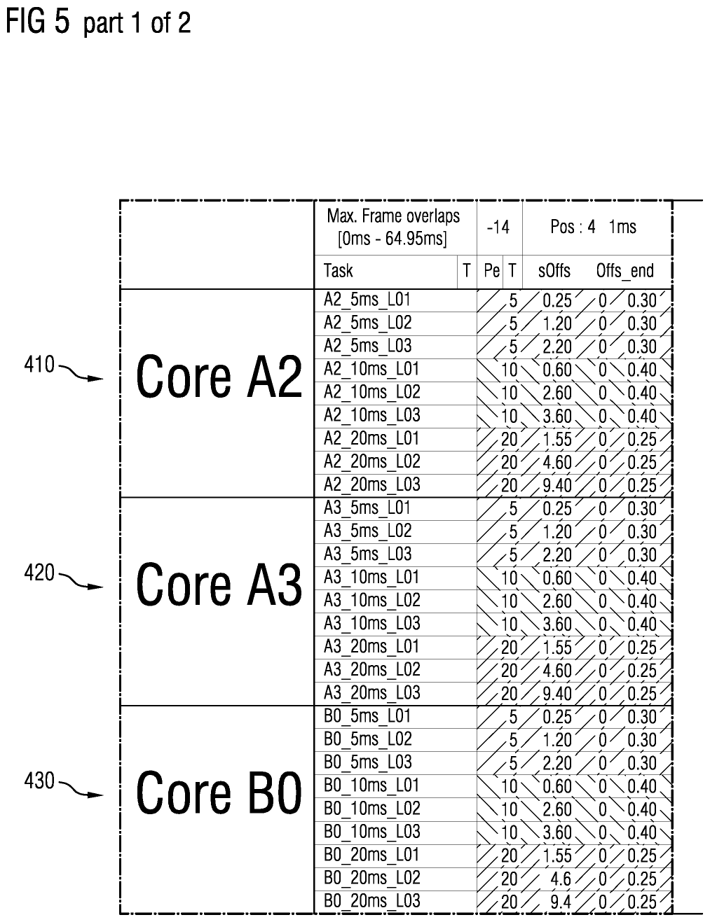

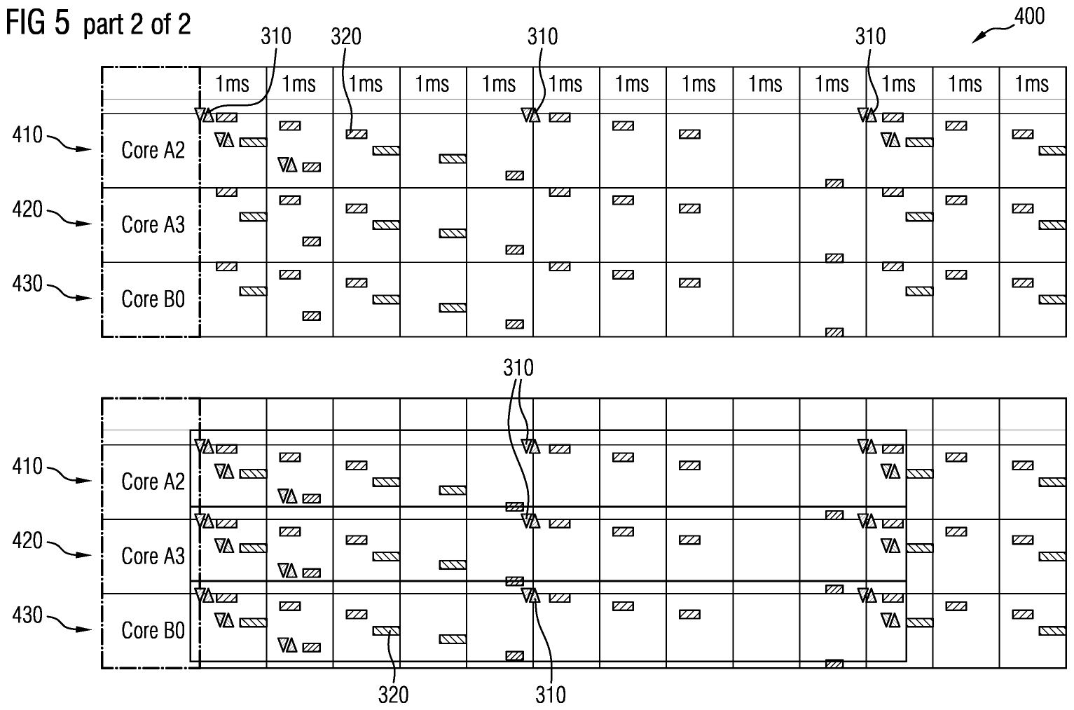

FIG. 5 shows a second executional schedule 400. The second executional schedule 400 includes two different schedules. Both schedules are used in a multicore microprocessor. The microprocessor which is used for execution of the second execution schedule 400 includes a first core A2 410, a second core A3 420 and a third core B0 430. Each core has a dedicated schedule which includes cross cluster communicational windows 310 and functional windows 320. The difference between the two schedules as shown in the second executional schedule 400 is that in the upper schedule all cross cluster communicational windows 310 are scheduled only in the first core A2 410. According to this example, all cross cluster communicational tasks are executed on the first core A2 410. The lower schedule of the second executional schedule 400 shows that on all cores include cross cluster communicational windows 310. Therefore, the cross cluster communicational tasks which are executed during the cross cluster communicational windows 310 are executed on all of the different cores 410, 420, 430.

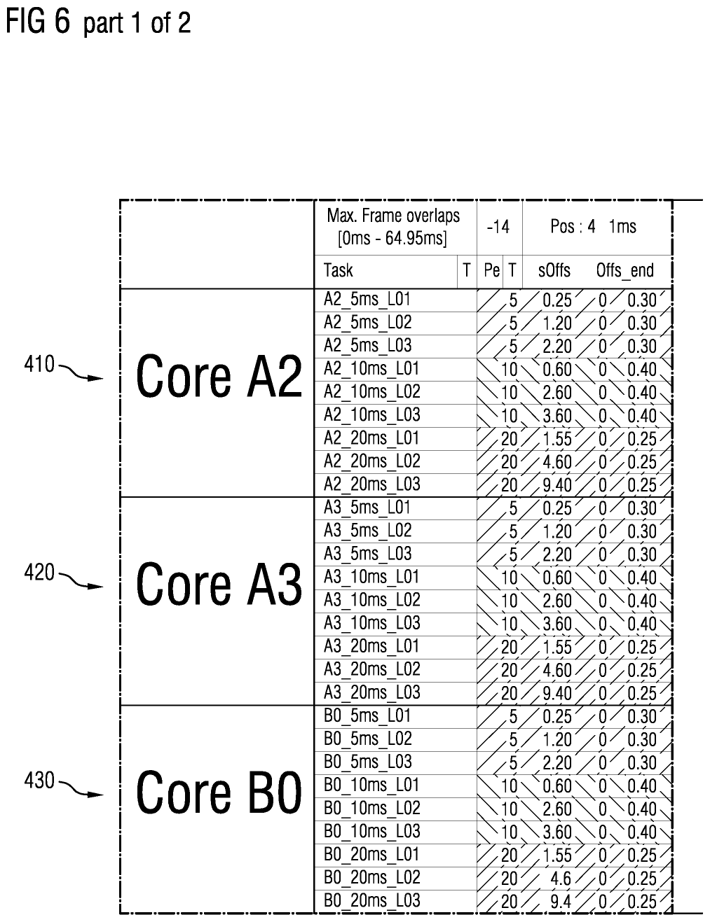

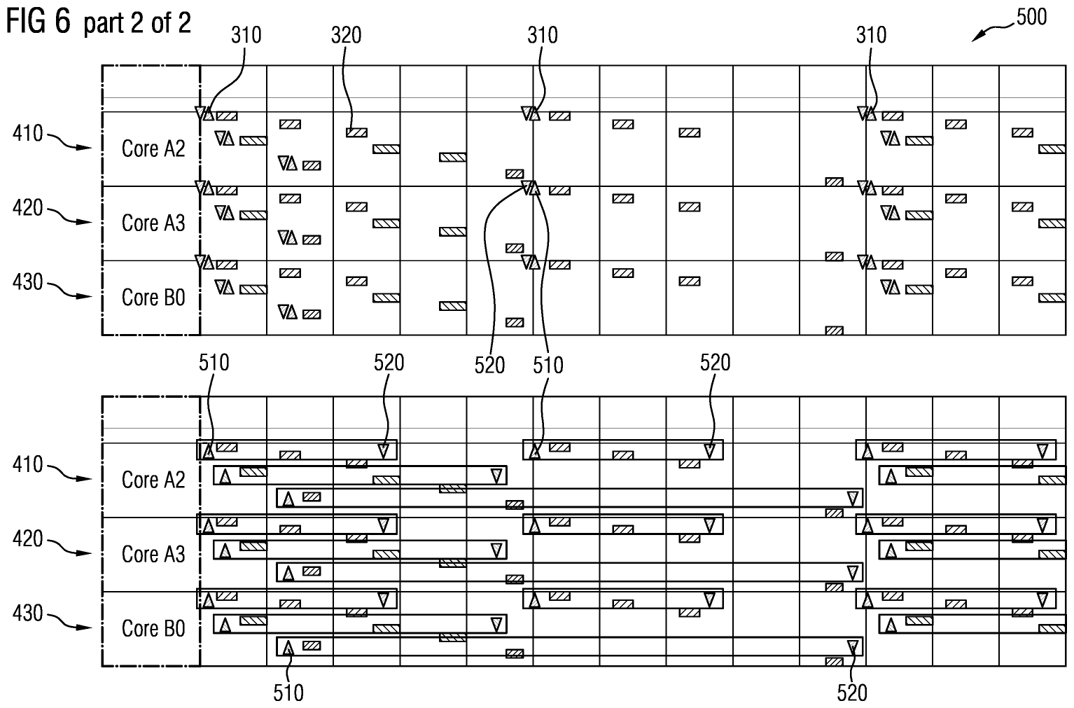

FIG. 6 shows a third executional schedule 500. Also, here the third executional schedule 500 shows two different schedules. The upper schedule shows cross cluster communicational windows 310, and functional windows 320. The cross cluster communicational windows 310 include a cross cluster communicational window for input communication 510 and a cross cluster communicational window for output communication 520. The cross cluster communicational window for input communication 510 and the cross cluster communicational window for output communication 520 is shown in FIG. 6 with two triangles where one triangle indicates the cross cluster communicational window for input communication 510 and the other triangle indicates the cross cluster communicational window for output communication 520. The upper schedule in FIG. 6 shows that the cross cluster communicational window for input communication 510 and the cross cluster communicational window for output communication 520 are combined together in the cross cluster communicational window 310 which means that the output communication and the input communication are executed after each other before a functional task is executed in a functional window 320. As it can be seen in the lower schedule of FIG. 6, the cross cluster communicational window for input communication 510 and the cross cluster communicational window for output communication 520 are separated across the overall schedule. In other words, as it can be seen in FIG. 6, the schedule starts with a cross cluster communicational window for input communication 510 which reads input data for different functional tasks. Afterwards, the schedule executes in different functional windows 320 different functional tasks and the period is completed by a cross cluster communicational window for output communication 520 which writes output data for a specific software cluster. The lower schedule of FIG. 6 shows a dedicated cross cluster communicational window for input communication 510 and a dedicated cross cluster communicational window for output communication 520 which allow a highly deterministic design of the overall schedule as desired with respect to required input data and/or with respect to provided output data.

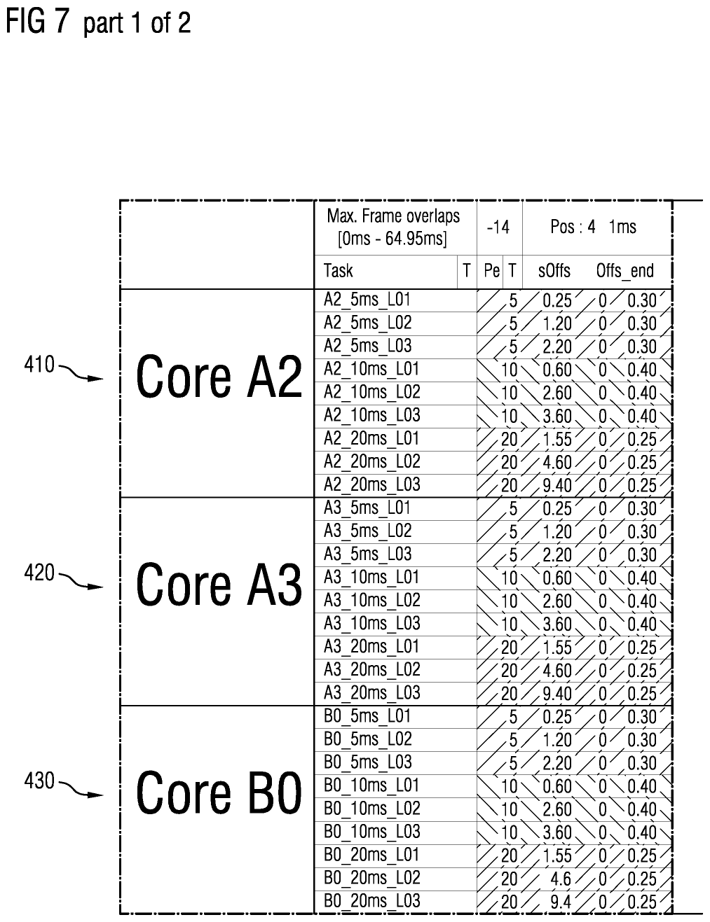

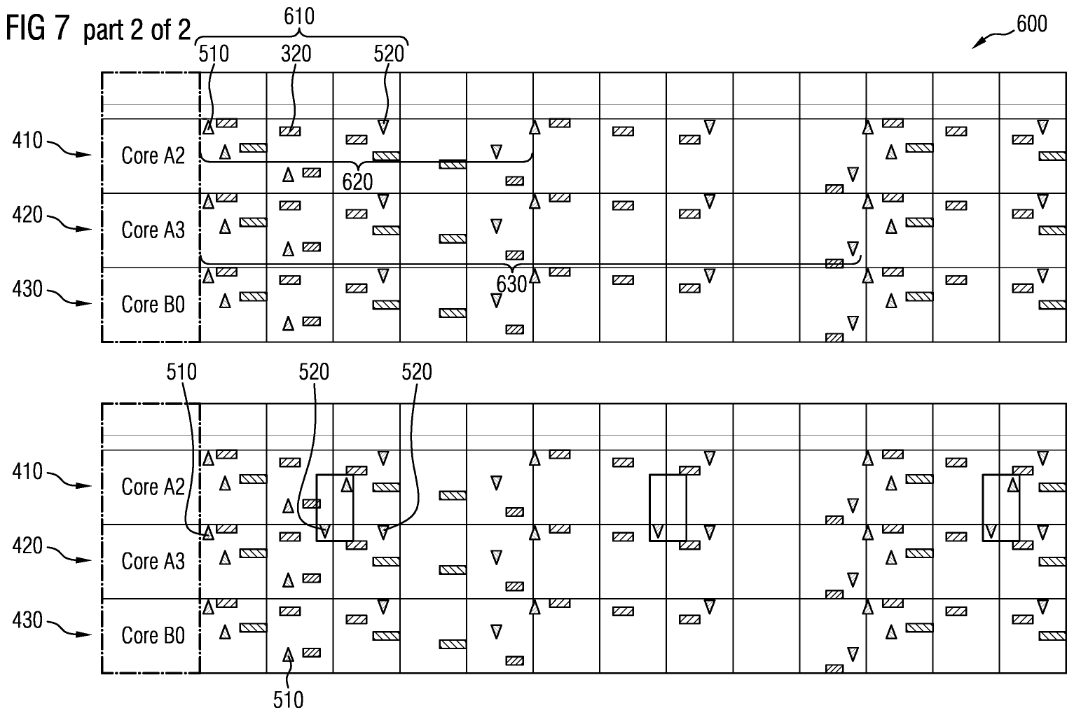

FIG. 7 shows a fourth execution schedule 600. Also, here the fourth execution schedule 600 is separated in an upper schedule and in a lower schedule. The fourth executional schedule 600 again shows different cross cluster communicational windows 310 which include cross cluster communicational windows for input communication 510 and cross cluster communicational windows for output communication 520. Further the fourth execution schedule 600 includes functional windows 320 for functional tasks. The fourth execution schedule 600 as shown in FIG. 7 further includes a first execution period 610, a second execution period 620, and a third execution period 630. The first execution period 610 is, for example, a five-millisecond execution period, the second execution period 620 is, for example, a ten-millisecond execution period and the third execution period 630 is, for example, a 20-millisecond execution period. This is indicated via the brackets as shown in FIG. 7. As it can be seen in the upper schedule the first execution period 610, the second execution period 620 and the third execution period 630 include only one cross cluster communicational window for input communication 510 and only one cross cluster communicational window for output communication 520. This is the case for each core 410, 420, 430. The lower schedule as shown in FIG. 7 differs in that within different execution periods it is possible that multiple cross cluster communicational windows for input communication 510 or multiple communicational windows for output communication 520 may be provided and executed. It is therefore possible to read input data more than one time within one execution period or to write output data more than one time within one execution period and therefore to communicate different data at different points in time.

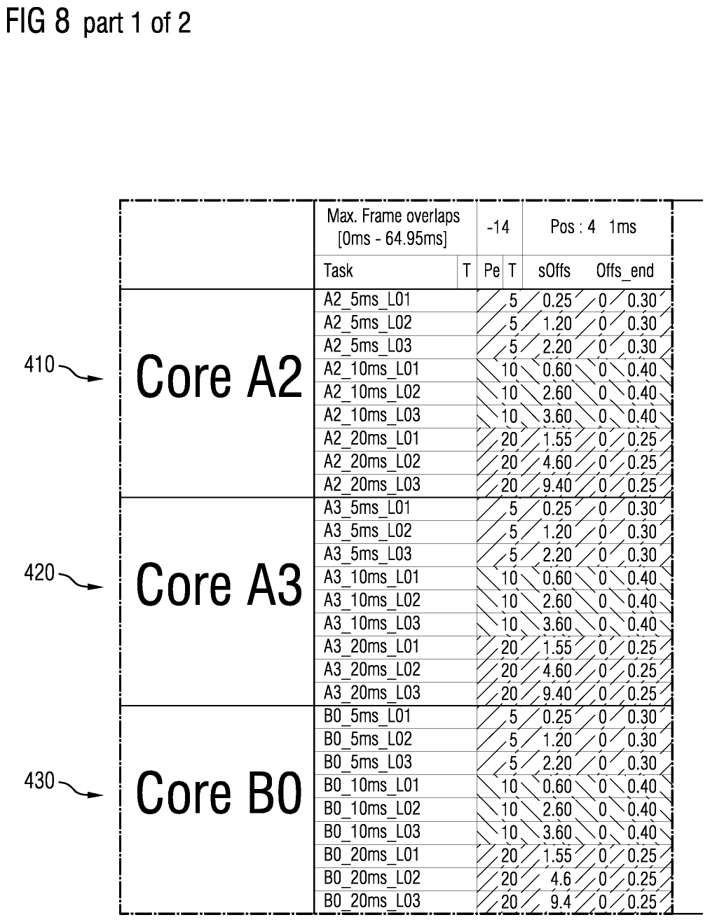

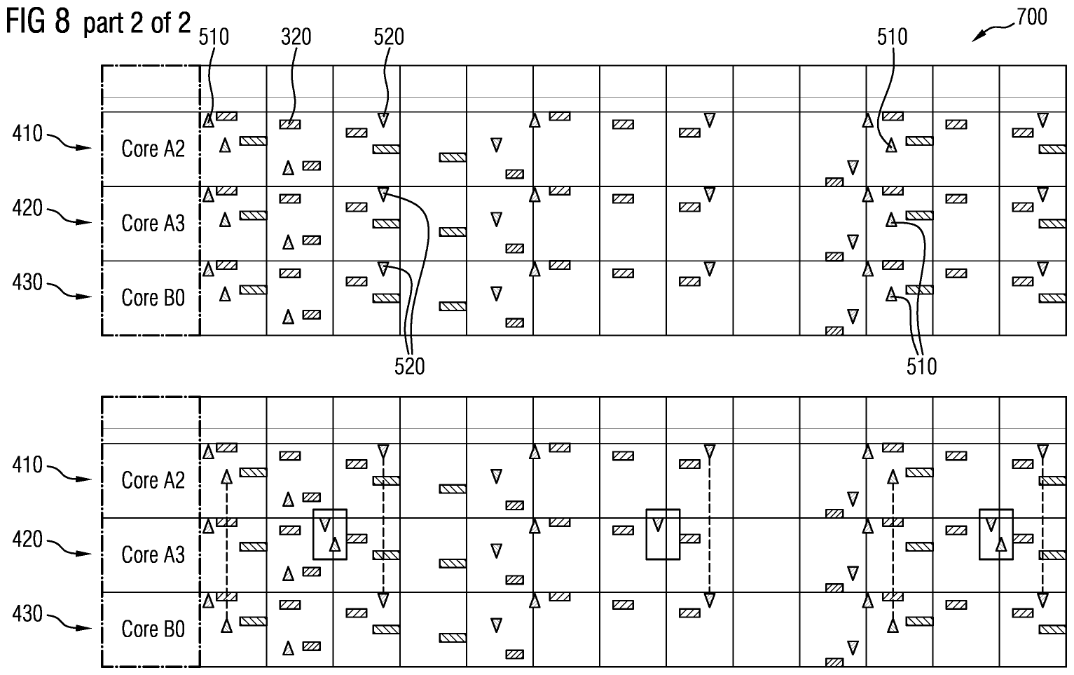

FIG. 8 shows a fifth execution schedule 700. The fifth execution schedule 700 also includes an upper schedule and a lower schedule. The difference in the fifth execution schedule 700 compared to the other executional schedules is that the cross cluster communicational windows for input communication 510 and/or the cross cluster communicational windows for output communication 520 are not always synchronized across the cores 410, 420, 430, which is shown in the lower schedule. In the upper schedule are the cross cluster communicational windows for input communication 510 and/or the cross cluster communicational windows for output communication 520 synchronized across the cores 410, 420, 430.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method for a deterministic data communication in a partitioned embedded system, a software of the embedded system comprises a plurality of software clusters, each software cluster includes functional tasks and cross cluster communicational tasks, the method comprises:
providing an execution schedule;
providing, in the execution schedule, predefined functional windows for the functional tasks of the plurality of the software clusters;
providing, in the execution schedule, dedicated cross cluster communicational windows for the cross cluster communicational tasks of the plurality of the software clusters, the cross cluster communication tasks provide cross cluster communication, the cross cluster communicational windows are distinct from the functional windows;
executing the execution schedule, wherein the functional tasks of the plurality of the software clusters are executed in the predefined functional windows and the cross cluster communication tasks of the plurality of the software clusters are executed in the dedicated cross cluster communication windows; and
realizing, the deterministic data communication in the partitioned embedded system for cross cluster communication by way of the execution schedule.

2. The computer-implemented method of claim 1, wherein:
the functional tasks of the software clusters have a determined priority,
the cross cluster communicational tasks of the software clusters have a determined priority, and
the priority of the cross cluster communicational tasks of the software clusters is higher compared to the priority of the functional tasks of the software clusters, so that a cross cluster communicational task is executed prior to a functional task, if they compete for computational resources.

3. The computer-implemented method of claim 1, wherein:
the software clusters comprise one cross cluster communicational window for input communication and/or one cross cluster communicational window for output communication,
in the cross cluster communicational window for input communication input communicational tasks read input data from at least one other software cluster, and
in the cross cluster communicational window for output communication output communicational tasks write output data for at least one other software clusters.

4. The computer-implemented method of claim 1, wherein a microprocessor of the partitioned embedded system comprises a plurality of cores and the cross cluster communicational tasks of the software clusters provide communication between different cores.

5. The computer-implemented method of claim 4, wherein all of the cross cluster communicational windows are provided only on one specific core of the microprocessor

6. The computer-implemented method of claim 4, wherein all of the cross cluster communicational windows are provided on different cores of the microprocessor.

7. The computer-implemented method of claim 4, wherein the dedicated cross cluster communicational window for input or output communication is followed by at least one functional window.

8. The computer-implemented method of claim 7, wherein the execution schedule comprises execution periods in which predefined functional tasks are executed, each execution period comprises only one cross cluster input communicational window and only one cross cluster output communicational window.

9. The computer-implemented method of claim 7, wherein the execution schedule comprises execution periods in which predefined functional tasks are executed, each execution period comprises one or more cross cluster input communicational windows and/or one or more cross cluster output communicational windows.

10. The computer-implemented method of claim 4, wherein at least two cross cluster communication windows are synchronized across at least two cores of at least one of the microprocessors.

11. An electronic control unit for a deterministic data communication, the electronic control unit is part of a partitioned embedded system, the embedded system comprises a plurality of software clusters, each software cluster includes functional tasks and cross cluster communicational tasks, the electronic control unit executes a computer-implemented method of claim 1.
